(19) United States
(12) Patent Application Publication
(10) Pub. No.: US 2015/0277272 A1
(43) Pub. Date: Oct. 1, 2015

(54) Image Forming Apparatus

(71) Applicant: Funai Electric Co., Ltd., Osaka (JP)

(72) Inventor: Katsuhiro AOKI, Kyoto-shi (JP)

(21) Appl. No.: 14/670,932

(22) Filed: Mar. 27, 2015

(30) Foreign Application Priority Data
Mar. 28, 2014 (JP) 2014-067543

(51) Int. Cl. G03G 15/00; G03G 15/02; G03G 15/06; G03G 15/16

(52) U.S. Cl. CPC G03G 15/065; G03G 15/1665

(57) ABSTRACT

An image forming apparatus comprising: a charging member (110) that receives application of a charge potential to charge an image bearing member (100); an exposing member (120) that exposes the image bearing member (100); a developing member (130) that receives application of a developing bias to form a toner image on the image bearing member (100) based on a state of the exposure; a transfer member (140) that receives application of a transfer bias to transfer the toner image formed on the image bearing member (100) to a recording medium; a transfer bias applicator (240) that applies a predetermined voltage to the transfer member (140); a current detector (250) that detects currents flowing through the transfer member (140) upon application of two or more kinds of voltages from the transfer bias applicator (240) to the transfer member (140); and a voltage determination unit (300) that determines a charge potential and a developing bias to be employed in image formation based on a predefined voltage decision table and a combination of the voltage applied by the transfer bias applicator (240) and the current detected by the current detector (250).

### BACKGROUND

1. Technical Field

An aspect of the present invention relates to an image forming apparatus configured to transfer a toner image formed on an image bearing member to a medium by using a transfer member.

2. Related Art

An image forming apparatus such as a laser printer of electrophotographic type performs image formation (printing) by using a photosensitive drum called an image bearing member to form an image with toner on a medium such as paper through a process of charging, exposing, developing, transferring, and fusing.

Such an image formation process may cause variations in the image formed on the medium due to changes in the states of the toner and other parts resulting from changes in the environment such as the temperature and humidity. The variations in the formed image include generation of sparse white portions in a black-out area, lightening of the entire printing color, and the like. To address such variations in the formed image, an image forming apparatus configured to change an applied voltage in accordance with the environment has been proposed.

JP2002-132069A discloses an image forming apparatus configured such that an output voltage of a constant-voltage power source outputted for image formation is determined in accordance with detection of the environment such as the temperature and humidity.

The above-described conventional configurations including the configuration disclosed in JP2002-132069A is, however, not adequate in terms of easy determination of an appropriate applied voltage in the image formation process. Therefore, further improvement has been required to respond to the variations in the formed image.

### SUMMARY

The present invention has been made to solve the problems described above, and an object of the present invention is to provide an image forming apparatus that is able to determine an optimal applied voltage in an image formation process with a relatively simple configuration.

To solve the above-described problems, the present invention adopts the following means. The description given below contains the reference signs on the drawings being placed in parentheses, merely for facilitation of understanding of the invention and not for limiting elements of the present invention. The elements should be construed as widely as within the technical purview of those skilled in the art.

A first aspect of the present invention is an image forming apparatus including:

a charging member (charging roller 110) that receives application of a charge potential to charge an image bearing member (photosensitive drum 100);

an exposing member (laser exposure device 120) that exposes the image bearing member;

a developing member (developing roller 130) that receives application of a developing bias to form a toner image on the image bearing member based on a state of the exposure;

a transfer member (transfer roller 140) that receives application of a transfer bias to transfer the toner image formed on the image bearing member to a recording medium;

a transfer bias applicator (transfer bias applicator 240) that applies a predetermined voltage to the transfer member;

a current detector (current detector 250) that detects currents flowing through the transfer member upon application of two or more kinds of voltages from the transfer bias applicator to the transfer member; and

a voltage determination unit (controller 300) that determines a charge potential and a developing bias to be employed in image formation based on a predefined voltage decision table and a combination of the voltage applied by the transfer bias applicator and the current detected by the current detector.

In this configuration, two or more kinds of voltages are applied to the transfer member, and based on current values detected, the charge potential and the developing bias are determined. This can suppress variations in image formation caused by generation of sparse white portions in a black-out area, lightening of the entire printing color, and the like. Accordingly, effective improvement in the quality of image formation is enabled.

A second aspect of the present invention is the above-described image forming apparatus, wherein

in the voltage decision table, the charge potential and the developing bias are determined based on a current difference between a first current value detected upon application of a first voltage to the transfer member and a second current value detected upon application of a second voltage to the transfer member.

This configuration is able to determine the charge potential and the developing bias through a relatively simple process based on the current difference between the detected currents.

A third aspect of the present invention is the above-described image forming apparatus, wherein

in the voltage decision table, the charge potential is determined in such a manner that a smaller potential difference is applied as the current difference between the first current value and the second current value is larger.

This configuration is able to determine a more appropriate charge potential based on the current difference between the detected currents, thus enabling improvement in the quality of image formation.

A fourth aspect of the present invention is the above-described image forming apparatus, wherein

in the voltage decision table, the developing bias is determined in such a manner that a smaller potential difference is applied as the current difference between the first current value and the second current value is larger.

This configuration is able to determine a more appropriate developing bias based on the current difference between the detected currents, thus enabling improvement in the quality of image formation.

A fifth aspect of the present invention is the above-described image forming apparatus, wherein

the charging member charges the image bearing member by being in contact with the image bearing member.

The image forming apparatuses include two types, namely, a contact type in which the charging member charges the image bearing member by being in contact with the image bearing member and a contactless type in which the charging member charges the image bearing member without any contact therewith. Experiments have revealed that generation of sparse white portions in a black-out area on a medium is more likely to occur in an image forming apparatus of the contact-type.

Application of the configuration of the present invention to an image forming apparatus of the contact type as mentioned above achieves effective suppression of generation of sparse white portions in a black-out area on a medium.

A sixth aspect of the present invention is the above-described image forming apparatus, wherein the transfer bias applicator includes a constant voltage source.

According to this configuration, an image forming apparatus capable of suppression of variations in image formation with a relatively simple configuration can be provided.

A seventh aspect of the present invention is the above-described image forming apparatus, further including a thermometer (thermometer 400) that detects ambient temperature, wherein

the voltage determination unit determines a charge potential and a developing bias to be employed in image formation based on a predefined voltage decision table, based on a combination of the voltage applied by the transfer bias applicator, the current detected by the current detector, and the temperature detected by the thermometer.

This configuration, in which the charge potential and the developing bias are determined in consideration of not only the current detected upon voltage application to the transfer roller but also ambient temperature, is able to determine the charge potential and the developing bias with an enhanced accuracy. Accordingly, an image forming apparatus capable of further suppression of variations in image formation can be provided.

An eighth aspect of the present invention is the above-described image forming apparatus, wherein

in the voltage decision table, the charge potential is determined in such a manner that a smaller potential difference is applied as the temperature is higher.

This configuration is able to determine a still more appropriate charge potential, thus enabling further improvement in the quality of image formation.

A ninth aspect of the present invention is the above-described image forming apparatus, wherein

in the voltage decision table, the developing bias is determined in such a manner that a smaller potential difference is applied as the temperature is higher.

This configuration is able to determine a still more appropriate developing bias, thus enabling further improvement in the quality of image formation.

### BRIEF DESCRIPTION OF THE DRAWINGS

FIG. 1 shows a configuration of an image forming apparatus according to an embodiment 1;

FIG. 2 shows the relationship between the environment and the resistance value of a transfer roller;

FIG. 3 shows the relationship between a voltage applied to the transfer roller and a detected current;

FIG. 4 shows voltage application to the transfer roller at a time of detection of the current, as plotted over time;

FIG. 5 shows the relationship between the environment and a difference in the detected currents;

FIG. 6 shows a combinations of a charge potential and a developing bias employed for each environmental condition; and

FIG. 7 shows a configuration of an image forming apparatus according to an embodiment 2.

### DESCRIPTION OF EXEMPLARY EMBODIMENTS

With reference to the drawings, a specific description of some embodiments of the present invention will be given based on the following configurations. It should be noted that the embodiments described below are merely illustrative examples of the present invention and not to be construed as limiting the technical scope of the present invention. In the drawings, the same elements are denoted by the same reference signs, and repetitive description may be omitted.

### 1. Embodiment 1

(1) Configuration of Image Forming Apparatus

(2) Relationship between Environment and Transfer Roller

(3) Process of Determining Charge Potential and Developing Bias

(4) Features of Image Forming Apparatus

### 2. Embodiment 2

### 3. Supplementary Remarks

### 1. Embodiment 1

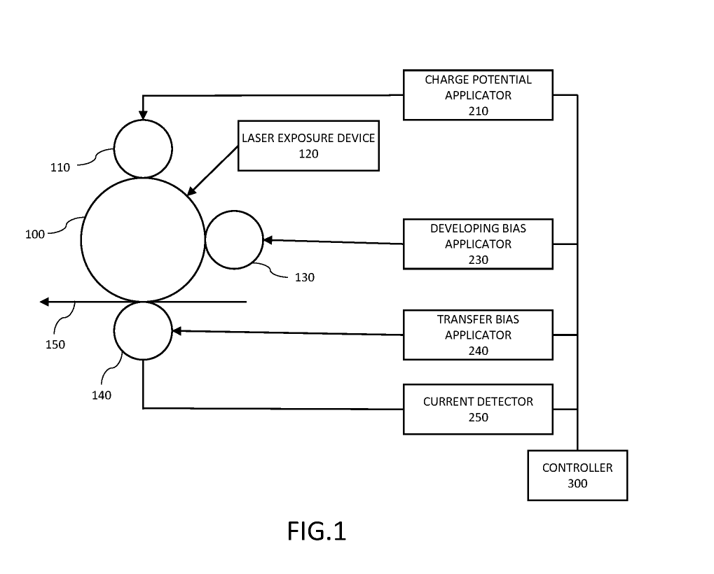

First, an embodiment 1 of the present invention will be described with reference to FIGS. 1 to 6.

((1) Exemplary Configuration of Image Forming Apparatus)

FIG. 1 shows a configuration of an image forming apparatus according to this embodiment. As shown in FIG. 1, the image forming apparatus of this embodiment includes a photosensitive drum 100, a charging roller 110, a laser exposure device 120, a developing roller 130, a transfer roller 140, a charge potential applicator 210, a developing bias applicator 230, a transfer bias applicator 240, a current detector 250, and a controller 300. The image forming apparatus forms an image with toner on a medium such as paper moving in the direction indicated by the arrow 150 in FIG. 1. The image forming apparatus of this embodiment is a so-called laser printer. The image formation with toner illustrated herein can be generally called printing.

(Photosensitive Drum 100)

The photosensitive drum 100 includes a cylindrical base having a photosensitive layer formed on a circumferential surface thereof. The base, which is made of a conductor such as aluminum, has its core portion grounded. The photosensitive layer is made of an inorganic or organic material.

(Charging Roller 110)

The charging roller 110, which is a cylindrical member made of a conductor, is arranged in tight contact with the photosensitive drum 100. The charging roller 110 is rotated along with rotation of the photosensitive drum 100. The charging roller 110 receives application of a predetermined charge potential from the charge potential applicator 210 which will be described later. The charge potential applicator 210 applies a predetermined charge potential to the charging roller 110 while the charging roller 110 and the photosensitive drum 100 are rotating relative to each other, and thereby a portion of the photosensitive drum 100 including the circumferential surface is uniformly charged to a predetermined potential having a predetermined polarity.

(Laser Exposure Device 120)

The laser exposure device 120 radiates laser light to the photosensitive drum 100 in accordance with an image to be formed on a medium. The photosensitive layer formed on the circumferential surface of the photosensitive drum 100 irradiated with the laser from the laser exposure device 120 is exposed, so that a latent image is formed.

(Developing Roller 130)

The developing roller 130, which is a cylindrical member made of a conductor, is configured to rotate with a toner layer formed on a circumferential surface thereof. The developing roller 130 is rotated along with rotation of the photosensitive drum 100. The developing roller 130 receives application of a developing bias from the developing bias applicator 230 which will be described later. The developing bias applicator 230 applies a predetermined developing bias to the developing roller 130 while the developing roller 130 and the photosensitive drum 100 are rotating relative to each other, and thereby a toner image is formed on the circumferential surface of the photosensitive drum 100 in accordance with the latent image.

(Transfer Roller 140)

The transfer roller 140 includes a shaft portion made of a conductor, and a conductive rubber portion formed on the circumference of the shaft portion. The rubber portion is made of a mixture of a conductive material and a rubber material such as urethane or silicone. The transfer roller 140 is rotated along with rotation of the photosensitive drum 100. A recording medium such as paper is nipped between the transfer roller 140 and the photosensitive drum 100. The recording medium is moved in the direction indicated by the arrow 150. The transfer roller 140 receives application of a transfer bias from the transfer bias applicator 240 which will be described later. The transfer bias applicator 240 applies a predetermined transfer bias to the transfer roller 140 while the photosensitive drum 100 having the toner image formed thereon and the transfer roller 140 are rotating relative to each other, and thereby the toner image is transferred to the recording medium such as paper. In this manner, the image with toner is formed on the recording medium. The toner image formed on the recording medium is fused by a fuser (not shown), and thus the image formation is completed.

(Charge Potential Applicator 210)

The charge potential applicator 210 applies a predetermined charge potential to the charging roller 110. The charge potential that the charge potential applicator 210 applies to the charging roller 110 is changed by the controller 300 depending on the environment.

(Developing Bias Applicator 230)

The developing bias applicator 230 applies a predetermined developing bias to the developing roller 130. The developing bias that the developing bias applicator 230 applies to the developing roller 130 is changed by the controller 300 depending on the environment.

(Transfer Bias Applicator 240)

The transfer bias applicator 240 applies a predetermined transfer bias to the transfer roller 140. The transfer bias applicator 240 includes a constant voltage source, and applies to the transfer roller 140 not only the above-mentioned transfer bias but also two or more kinds of predetermined voltages that have been set in advance.

(Current Detector 250)

The current detector 250 detects a current that flows through the transfer roller 140 upon application of the transfer bias to the transfer roller 140 from the transfer bias applicator 240. The current detector 250 outputs a detected current value to the controller 300.

(Controller 300)

The controller 300 controls a voltage of the charge potential that the charge potential applicator 210 applies to the charging roller 110, a voltage of the developing bias that the developing bias applicator 230 applies to the developing roller 130, and a voltage of the transfer bias that the transfer bias applicator 240 applies to the transfer roller 140. The controller 300 performs a control of changing at least the charge potential and the developing bias in accordance with the current flowing through the transfer roller 140 that is received from the current detector 250. At this time, the controller 300 refers to a voltage decision table that is preliminarily recorded in a memory of the controller 300, to determine the charge potential and the developing bias based on a combination of the two or more kinds of voltages applied by the transfer bias applicator 240 and the current values detected by the current detector 250. A specific description of the process will be given later.

((2) Relationship Between Environment and Transfer Roller)

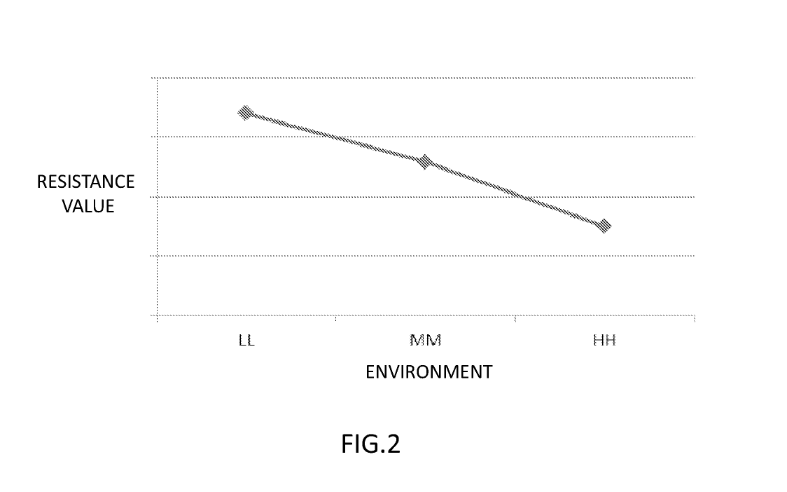

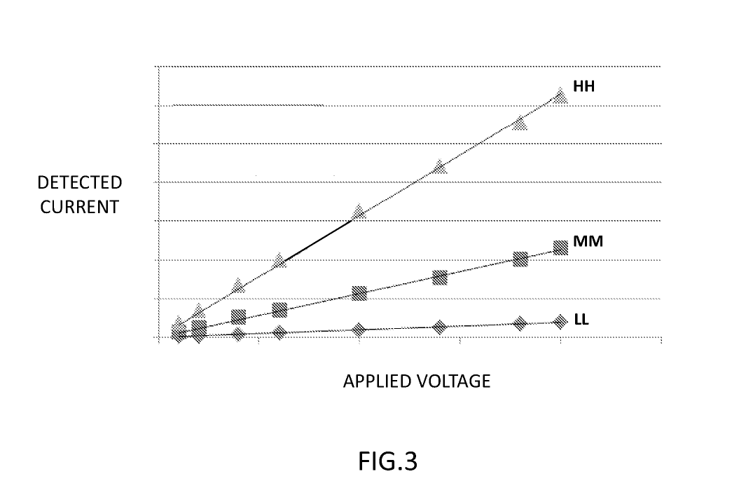

Next, the relationship between the resistance value of the transfer roller and the environment at the time of image formation, which was verified by experiments, will be described with reference to FIGS. 2 and 3.

FIG. 2 shows the relationship between the environment and the resistance value of the transfer roller. FIG. 2 shows results of experiments performed to find out how the resistance value of the transfer roller 140 differs among three kinds of environments whose factors include the temperature and humidity, and more specifically, among three states of high-temperature/high-humidity (HH), middle-temperature/middle-humidity (MM), and low-temperature/low-humidity (LL). As shown in FIG. 2, the experimental results indicate that the resistance value of the transfer roller 140 was highest in the environment of low-temperature/low-humidity (LL), and the resistance value decreased as the temperature and humidity increased, that is, the resistance value decreased in the environment of middle-temperature/middle-humidity (MM) and further decreased in the environment of high-temperature/high-humidity (HH).

The experimental results described above reveal that the resistance value of the transfer roller 140 decreases in the order of low-temperature/low-humidity (LL)>middle-temperature/middle-humidity (MM)>high-temperature/high-humidity (HH), which means that the current value of the current flowing upon application of a constant voltage increases in this order.

FIG. 3 shows the relationship between the voltage applied to the transfer roller and the detected current. Experimental results shown in FIG. 3 are results of detection of currents that flowed through the transfer roller 140 upon application of eight kinds of voltages to the transfer roller 140 under the three conditions of low-temperature/low-humidity (LL), middle-temperature/middle-humidity (MM), and high-temperature/high-humidity (HH). As shown in FIG. 3, a proportionate relationship was observed between the applied voltage and the detected current in each of the environments. This leads to the understanding that the resistance value of the transfer roller 140 is constant under the same environment.

To be more specific, under the condition of high-temperature/high-humidity (HH) in which the resistance value of the transfer roller 140 is lower, a current difference between currents detected upon application of two kinds of different voltages is larger as compared with under the condition of low-temperature/low-humidity (LL). On the other hand, under the condition of low-temperature/low-humidity (LL) in which the resistance value of the transfer roller 140 is higher, a current difference between currents detected upon application of two kinds of different voltages is smaller as compared with under the condition of high-temperature/high-humidity (HH).

((3) Process of Determining Charge Potential and Developing Bias)

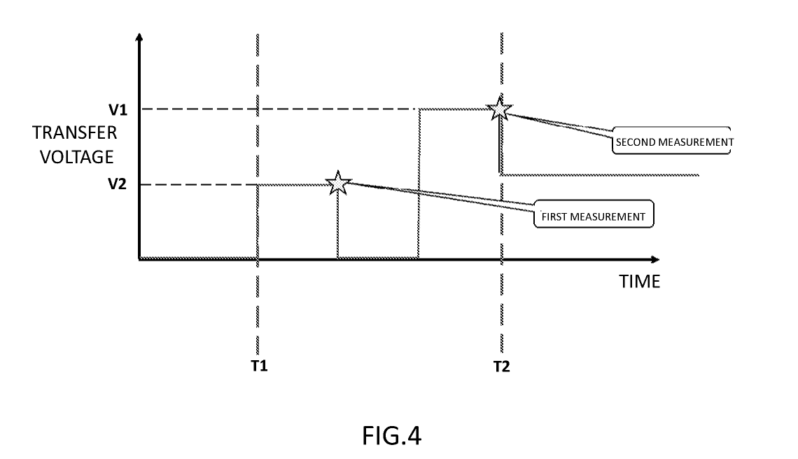

Next, a process of determining the charge potential and the developing bias will be described with reference to FIGS. 4 to 6.

FIG. 4 shows a change over time in the voltage that the transfer bias applicator 240 applies to the transfer roller 140 at times when the current detector 250 detects a current for the process of determining the charge potential and the developing bias. As shown in FIG. 4, the transfer bias applicator 240 applies a transfer voltage V1 and a transfer voltage V2 to the transfer roller 140, each for a predetermined period of time at an interval therebetween. The interval equals the predetermined period of time. For example, the interval is 30 ms. That is, the application of the voltage V2, the interval, and the application of the voltage V1 occur each 30 ms. The current detector 250 detects a current flowing through the transfer roller 140 at timings of a first measurement and a second measurement shown in FIG. 4. The current values detected by the current detector 250 are outputted to the controller 300.

The controller 300 receives the current values obtained by the two detections from the current detector 250, and calculates a current difference between the currents obtained by the two detections. Here, the current detected by the current detector 250 depends on the voltage applied by the transfer bias applicator 240 and the resistance value of the transfer roller 140, which varies depending on the environment. Therefore, the calculated current difference reflects the resistance value varying depending on the environment. As described above, when a calculated current difference is larger, it indicates that the resistance value of the transfer roller 140 is lower, and when a calculated current difference is smaller, it indicates that the resistance value of the transfer roller 140 is higher.

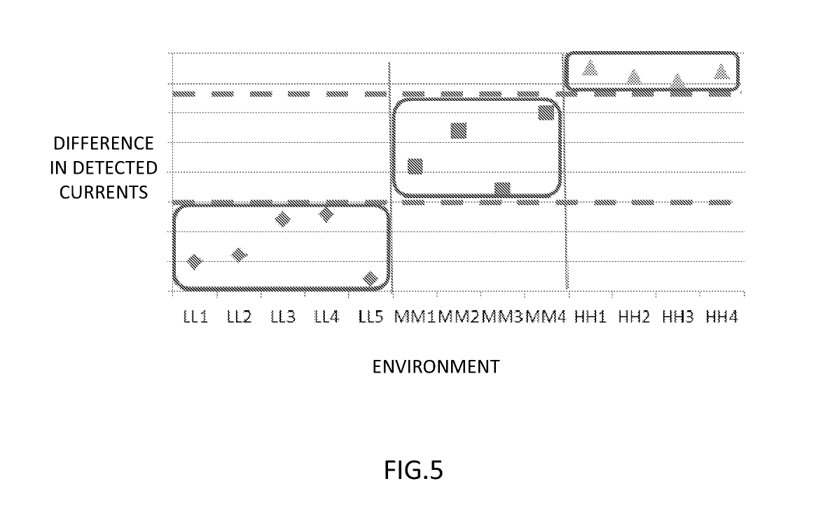

FIG. 5 shows the relationship between the environment and the difference in the detected currents. FIG. 5 shows results of a plurality of experiments performed in each of the environments of high-temperature/high-humidity (HH), middle-temperature/middle-humidity (MM), and low-temperature/low-humidity (LL). As shown in FIG. 5, the difference in the detected currents calculated in each of the environments is within a certain range. Therefore, the environment is identifiable based on the difference in the detected currents. More specifically, use of two threshold values indicated by the dotted lines in FIG. 5 enables the three environments to be ascertained based on the difference in the detected currents.

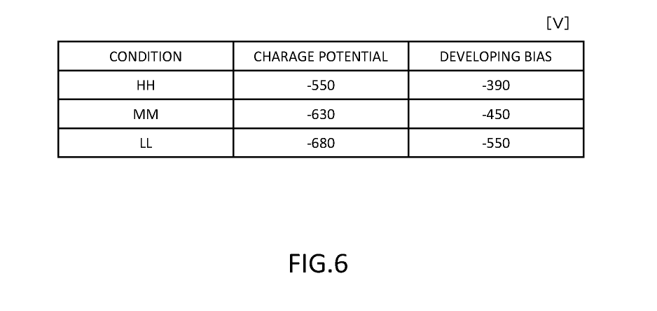

The controller 300 is able to identify whether the environment is high-temperature/high-humidity (HH), middle-temperature/middle-humidity (MM), or low-temperature/low-humidity (LL), from the current difference calculated based on the current values obtained by two detections that are received from the current detector 250. Then, the controller 300 refers to a voltage decision table shown in FIG. 6 which is preliminarily provided and recorded in the memory of the controller 300, and determines the charge potential and the developing bias in accordance with the environment. The charge potential and the developing bias determined at this time are, in subsequent image formation, employed by the charge potential applicator 210 and the developing bias applicator 230, respectively. As shown in FIG. 6, in the environment of high-temperature/high-humidity (HH), the charge potential is set to −550V and the developing bias is set to −390V, while in the environment of low-temperature/low-humidity (LL), the charge potential is set to −680V and the developing bias is set to −550V. In the environment of high-temperature/high-humidity (HH), as compared with the environment of low-temperature/low-humidity (LL), smaller values are determined as the potential difference of the voltage to be applied to the charging roller 110 and as the potential difference of the voltage to be applied to the developing roller 130.

In other words, when the current difference calculated based on the current values obtained by two detections that are received from the current detector 250 is larger, the controller 300 determines that the environment is closer to high-temperature/high-humidity (HH), and therefore determines the charge potential and the developing bias in such a manner that smaller potential differences are applied to the charging roller 110 and the developing roller 130. When the current difference calculated in the same manner is smaller, the controller 300 determines that the environment is closer to low-temperature/low-humidity (LL), and therefore determines the charge potential and the developing bias in such a manner that larger potential differences are applied to the charging roller 110 and the developing roller 130. It may be acceptable that the controller 300 performs a control of changing only one of the charge potential and the developing bias, but it is more preferable that both the charge potential and the developing bias are changed appropriately.

((4) Features of Image Forming Apparatus)

With the above-described configuration and operation, the charge potential that the charge potential applicator 210 applies to the charging roller 110 and the developing bias that the developing bias applicator 230 applies to the developing roller 130 are determined. The image forming apparatus of this embodiment has the following features.

The image forming apparatus of this embodiment includes: a charging member (charging roller 110) that receives application of a charge potential to charge an image bearing member (photosensitive drum 100); an exposing member (laser exposure device 120) that exposes the image bearing member; a developing member (developing roller 130) that receives application of a developing bias to form a toner image on the image bearing member in accordance with a state of the exposure; a transfer member (transfer roller 140) that receives application of a transfer bias to transfer the toner image formed on the image bearing member to a recording medium; a transfer bias applicator (transfer bias applicator 240) that applies a predetermined voltage to the transfer member; a current detector (current detector 250) that detects currents flowing through the transfer member upon application of two or more kinds of voltages from the transfer bias applicator to the transfer member; and a voltage determination unit (controller 300) that determines a charge potential and a developing bias to be employed in image formation based on a predefined voltage decision table, in accordance with a combination of the voltage applied by the transfer bias applicator and the current detected by the current detector.

In this image forming apparatus, two or more kinds of voltages are applied to the transfer member (transfer roller 140), and based on the current values detected, the charge potential and the developing bias are determined. This can suppress variations in image formation caused by generation of sparse white portions in a black-out area, lightening of the entire printing color, and the like. Accordingly, effective improvement in the quality of image formation is enabled.

In the image forming apparatus of this embodiment, the charging member charges the image bearing member by being in contact with the image bearing member.

The image forming apparatuses include two types, namely, a contact type in which the charging member charges the image bearing member by being in contact with the image bearing member and a contactless type in which the charging member charges the image bearing member without any contact therewith. The experiments conducted by the inventors have revealed that generation of sparse white portions in a black-out area on a medium is more likely to occur in an image forming apparatus of the contact-type.

Application of the configuration of the present invention to an image forming apparatus of the contact type as illustrated in this embodiment achieves effective suppression of generation of sparse white portions in a black-out area on a medium.

This, however, does not exclude image forming apparatuses of contactless type, because the image forming apparatuses of contactless type can also provide the effects to a certain extent.

In the image forming apparatus of this embodiment, the transfer bias applicator includes a constant voltage source.

According to the above configuration, the image forming apparatus capable of suppression of variations in image formation with a relatively simple configuration can be provided.

In the image forming apparatus of this embodiment, the charge potential and the developing bias are determined by using the current values detected upon application of voltages to none other than the transfer member (transfer roller 140). The reason why the voltage application and the current detection are performed on the transfer member (transfer roller 140) is because the transfer member (transfer roller 140) causes a larger variation in its resistance value due to a change in the environment than another member such as the charging roller 110 does. Performing the voltage application and the current detection on the transfer roller 140 enables accurate detection of changes in the environment.

### 2. Embodiment 2

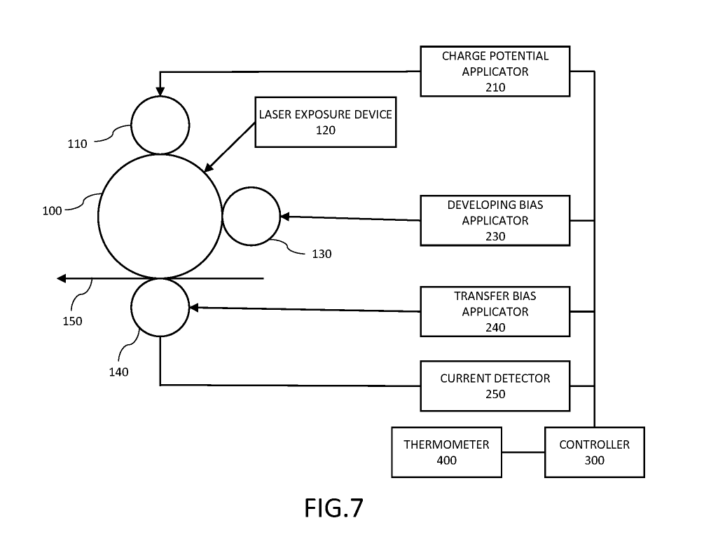

An embodiment 2 of the present invention will be described with reference to FIG. 7. This embodiment is different from the embodiment 1 in that a thermometer 400 is additionally provided so that a process with use of the thermometer 400 is additionally performed. In the following description, a specific description will be given only of differences from the embodiment 1, and functions and processes similar to those of the embodiment 1 are not described.

FIG. 7 shows a configuration of an image forming apparatus according to this embodiment. As shown in FIG. 7, the image forming apparatus of this embodiment includes a thermometer 400 in addition to the configurations provided in the image forming apparatus of the embodiment 1, namely, the photosensitive drum 100, the charging roller 110, the laser exposure device 120, the developing roller 130, the transfer roller 140, the charge potential applicator 210, the developing bias applicator 230, the transfer bias applicator 240, the current detector 250, and the controller 300.

(Thermometer 400)

The thermometer 400 is arranged near the photosensitive drum 100 and the like, and detects the temperature of the surroundings thereof. For example, a thermometer built in a microcomputer of a main board provided in the image forming apparatus, on which a power supply circuit, the microcomputer, and the like, are mounted, is used as the thermometer 400. The thermometer 400 outputs information of the detected ambient temperature to the controller 300.

(Controller 300)

The controller 300 receives the information about ambient temperature from the thermometer. The controller 300 performs a control of changing the charge potential and the transfer bias in accordance with the information of ambient temperature received from the thermometer 400 and the current flowing through the transfer roller 140 received from the current detector 250.

As described above, the image forming apparatus of this embodiment includes the thermometer (thermometer 400) that detects ambient temperature in addition to the configurations of the embodiment 1. The voltage determination unit (controller 300) determines the charge potential and the developing bias to be employed in image formation based on the predefined voltage decision table, in accordance with a combination of the voltage applied by the transfer bias applicator (transfer bias applicator 240), the current detected by the current detector (current detector 250), and the temperature detected by the thermometer.

Such a configuration, in which the charge potential and the developing bias are determined in consideration of not only the detected current but also ambient temperature, is able to determine the charge potential and the developing bias with an enhanced accuracy. Accordingly, the image forming apparatus capable of further suppression of variations in image formation can be provided.

### 3. Supplementary Remarks

Hereinbefore, specific descriptions of the embodiments of the present invention have been given. These embodiments are merely illustrative. The scope of the present invention is not restricted to the illustrative embodiments. The present invention should be construed as widely as those skilled in the art can appreciate.

Although the above-described embodiments illustrate the example case where the charge potential and the developing bias are changed in accordance with changes in the environment, it may be acceptable that other factors such as the applied voltage are changed together with the charge potential and the developing bias.

Although the above-described embodiments illustrate the example case where the currents flowing upon application of two kinds of voltages to the transfer roller 140 are detected, it may be acceptable that currents flowing upon application of three or more kinds of voltages to the transfer roller 140 are detected.

In the above-described embodiments, three types of environments of high-temperature/high-humidity (HH), middle-temperature/middle-humidity (MM), and low-temperature/low-humidity (LL) are adopted, and the charge potential and the developing bias are set for each of the environments. Instead, however, four or more combinations of the charge potential and the developing bias may be adoptable for corresponding types of environments, respectively. In such a case as well, the controller 300 determines the charge potential and the developing bias in accordance with a combination of the applied voltage and the current.

In the above-described embodiments, it is preferable that the process of determining the charge potential and the developing bias based on the voltage application to and the current detection in the transfer roller 140 is performed each time image formation is started. Accordingly, even though the environment has changed from the time of previous printing, image formation can be performed with an appropriate charge potential and an appropriate developing bias in accordance with the environment at the time of starting the current image formation.

The thermometer 400 of the second embodiment may be provided separately from the microcomputer.

The present invention may be suitable for application to a printing apparatus serving as an image forming apparatus.

What is claimed is:

1. An image forming apparatus comprising:
a charging member that receives application of a charge potential to charge an image bearing member;
an exposing member that exposes the image bearing member;
a developing member that receives application of a developing bias to form a toner image on the image bearing member based on a state of the exposure;
a transfer member that receives application of a transfer bias to transfer the toner image formed on the image bearing member to a recording medium;
a transfer bias applicator that applies a predetermined voltage to the transfer member;
a current detector that detects currents flowing through the transfer member upon application of two or more kinds of voltages from the transfer bias applicator to the transfer member; and
a voltage determination unit that determines a charge potential and a developing bias to be employed in image formation based on a predefined voltage decision table and a combination of the voltage applied by the transfer bias applicator and the current detected by the current detector.

2. The image forming apparatus according to claim 1, wherein
in the voltage decision table, the charge potential and the developing bias are determined based on a current difference between a first current value detected upon application of a first voltage to the transfer member and a second current value detected upon application of a second voltage to the transfer member.

3. The image forming apparatus according to claim 2, wherein
in the voltage decision table, the charge potential is determined in such a manner that a smaller potential difference is applied as the current difference between the first current value and the second current value is larger.

4. The image forming apparatus according to claim 2, wherein
in the voltage decision table, the developing bias is determined in such a manner that a smaller potential difference is applied as the current difference between the first current value and the second current value is larger.

5. The image forming apparatus according to claim 1, wherein
the charging member charges the image bearing member by being in contact with the image bearing member.

6. The image forming apparatus according to claim 1, wherein
the transfer bias applicator includes a constant voltage source.

7. The image forming apparatus according to claim 1, further comprising a thermometer that detects ambient temperature, wherein
the voltage determination unit determines a charge potential and a developing bias to be employed in image formation based on a predefined voltage decision table and a combination of the voltage applied by the transfer bias applicator, the current detected by the current detector, and the temperature detected by the thermometer.

8. The image forming apparatus according to claim 7, wherein
in the voltage decision table, the charge potential is determined in such a manner that a smaller potential difference is applied as the temperature is higher.

9. The image forming apparatus according to claim 7, wherein
in the voltage decision table, the developing bias is determined in such a manner that a smaller potential difference is applied as the temperature is higher.
